(19) United States
(12) Patent Application Publication
(10) Pub. No.: US 2018/0181718 A1
(43) Pub. Date: Jun. 28, 2018

(54) INTERACTIVE CLINICAL DECISION SUPPORT SYSTEM

(71) Applicant: King Abdulaziz University, Jeddah (SA)

(72) Inventor: Galila ZAHER, Jeddah (SA)

(73) Assignee: King Abdulaziz University, Jeddah (SA)

(21) Appl. No.: 15/389,994

(22) Filed: Dec. 23, 2016

(51) Int. Cl. G06F 19/00

(52) U.S. Cl. CPC G06F 19/345; G06F 19/321; G06F 19/322; G06F 19/327; G06F 19/363

(57) ABSTRACT

An interactive clinical decision support system and method is presented. The support system includes a mobile device, a database having up-to-date medical guidelines, and a network. The support system may further include one or more sensors configured to provide patient information. The interactive method includes steps of calculating scores based on clinical studies, which use patient information to generate an initial management plan recommendation and management plan rating. The method further includes a clinician discretion factor to balance benefits, risks, burdens, and costs of obtaining unknown patient information. A significance value of each patient information which may result in a management plan with a stronger recommendation, is calculated and ranked according to the clinician discretion factor. A set of unknown patient information is presented as options for creating a clinical order that will be executed once selected.

### BACKGROUND

Medical knowledge is growing at a faster rate than healthcare providers can keep up with in every specialty. Medical panels are increasingly adding clinical guidelines and recommendations to aid clinicians in patient management. At the same time, there is an unequal geometric distribution of clinicians, with very low clinician-to-population ratios resulting in a severe shortage of trained doctors and nurses in rural areas. Many medical conditions require quick and immediate risk assessment upon admission. A deep venous thrombosis (DVT) or thrombosis and a pulmonary embolism (PE) are common causes of death in hospitalized patients, which can be prevented by early detection or prophylactic measures. Patients with different backgrounds or those with comorbidities require varying diagnosis methods, treatment plans, and prophylactic strategies. While, thrombosis is a medical risk that has a higher risk profile for patients having certain risk factors, the risk is present in patients of all socioeconomic classes and comorbidities having time sensitivities. Therefore, a clinician's discretion is often used to balance benefits, risks, burdens, and costs of intervention. Where time and available resources are significant factors considered by the clinician, healthcare providers need to have a quicker and interactive way of assessing their patient's circumstances with more confidence in their decision-making.

### SUMMARY OF THE INVENTION

An interactive clinical decision support system and method is presented. The support system includes a mobile device, a server, a database having up-to-date medical guidelines, and a network. The support system may further include one or more sensors configured to provide patient information. The method includes continuous calculations of one or more stratifying scores and risk stratifications based on scoring systems from a set of clinical studies requiring different sets of patient information. The patient information and applicable clinical studies are used to generate an initial management plan recommendation and an initial management plan rating. A clinician discretion factor such as emphasis on a medical factor, as well as timeliness, resources, required and cost of obtaining unknown patient information, is input to rank a balance among benefits, risks, burdens, and costs of obtaining the unknown patient information. A significance value of each unknown patient information that may result in a management plan with a stronger recommendation is calculated. A set of unknown patient information is displayed as a set of options for creating a clinical order that will be executed once selected. An example for thrombosis diagnosis, management, and prophylaxis is presented.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a system overview of an interactive clinical decision support system according to one example;

FIG. 1B is a system overview of an interactive clinical decision support system including an imaging sensor and a patient according to one example;

FIG. 2A is an exemplary block diagram of a mobile device according to one example;

FIG. 2B is a block diagram illustrating another example of the mobile device;

FIG. 2C is an exemplary block diagram of a server according to one example;

FIG. 3A is a diagram showing the relationship between a set of patient information to a clinical recommendation according to one example;

FIG. 3B is a diagram showing an example of the relationship between a set of patient information to a clinical recommendation;

FIG. 4A is a diagram showing the effect of a clinician discretion factor to a set of optional patient information and a clinical recommendation according to one example;

FIG. 4B is a diagram showing the effect of a clinician discretion factor to a set of optional patient information and a clinical recommendation according to one example;

FIG. 4C is a diagram showing the effect of a clinician discretion factor to a set of optional patient information and a clinical recommendation according to one example;

FIG. 4D is a diagram showing the effect of a clinician discretion factor to a set of optional patient information and a clinical recommendation according to one example;

FIG. 5 is an example of a touch display on the mobile device showing a list of selectable options for gathering patient information;

FIG. 6 is a flowchart showing the process of performing an interactive clinical decision according to one example; and

FIG. 7 is a flowchart showing an alternate example of the process of performing an interactive clinical decision according to one example.

### DETAILED DESCRIPTION

Clinicians use evidence-based clinical practice guidelines, which are hundreds of recommendations based on quantitative and qualitative criteria. However, clinicians must also consider non-medical factors in their practice, often requiring them to make compromises on the patient information they use resources to obtain. This invention allows for a clinician discretion factor to be included in the determination of the resources to use to get the required patient information for the best available evidence-based clinical practice guidelines for diagnosis, management, and prophylaxis treatment of a disease or medical condition.

Different types of patient information have varying availability and resource requirements for accessibility. Unknown patient information means any patient information that is not known or currently available. For instance, patient demographic information, clinical observations, or patient vitals information may be quickly and easily obtained without additional cost; whereas, blood work lab results and medical imaging information require additional procedures, expensive resources, and time. These availability and resource requirements may be factored into the clinical decision practice by the discretion of the clinician.

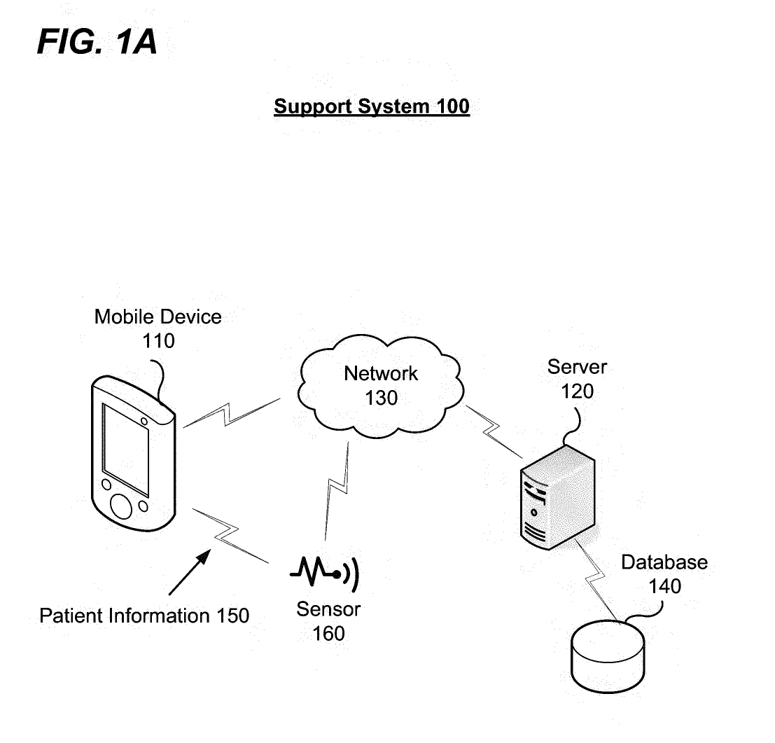

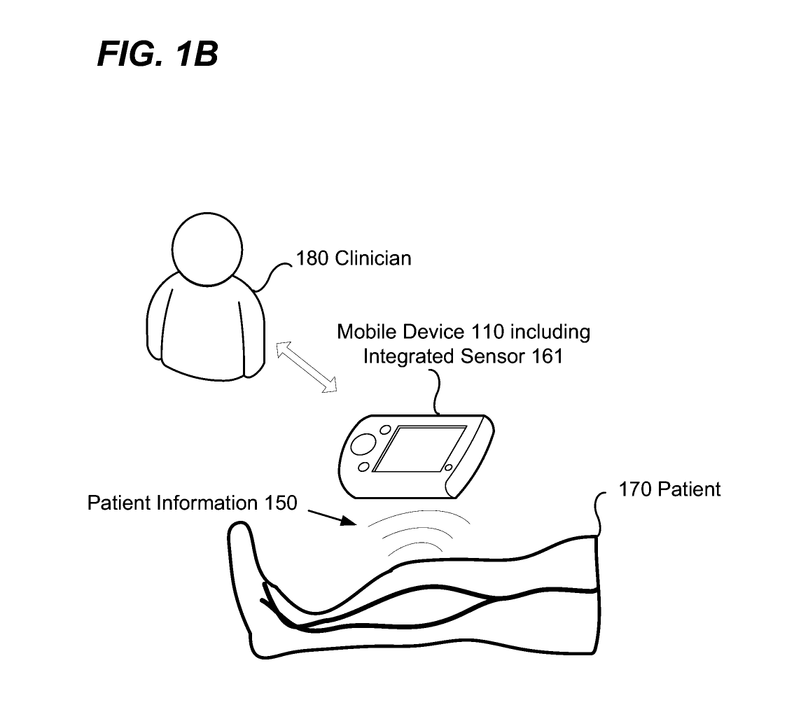

FIG. 1A shows an exemplary example of an interactive clinical decision support system 100 (support system) including a mobile device 110, a server 120, a network 130, and at least one database 140. In another exemplary example, the support system 100 includes one or more sensors 160. The one or more sensors 160 provide patient information 150 to the mobile device 110 remotely through the network 130. Alternatively, the one or more sensors 160 are included as part of the mobile device 110 and communicate the patient information 150 directly. The mobile device 110 can be a portable cellular device, a portal computer or the like.

Each sensor 160 includes a sensor system. The sensors 160 are configured for measuring at least one of a pulse oximetry, a body temperature, a heart rate, and sweating. The one or more sensor systems may include an electroderm system and a barcode reader system to provide patient identification. In one example, the sensor system is a Doppler ultrasound system to diagnose DVT and facilitate integration of the patient information 150 to the mobile device 110. In another example, the sensor system is a vein imaging system having a near infrared imaging sensor.

The server 120 connects the network 130 to the one or more databases 140. In an example, the database 140 stores an electronic medical record database (EMR), a set of clinical studies, and a set of management plans. The EMR stores the patient information 150 and can be used as temporary storage for transferring the patient information from a peripheral device or peripheral storage. In an example, the EMR may be a National database.

The network 130 is any network or circuitry that allows the mobile device 110, the database 140, the server 120, and the one or more sensors 160 to communicate information with each other such as a Wide Area Network, Local Area Network or the Internet. The network 130 may include the Internet or any other network capable of communicating data between devices. Suitable networks can include or interface with any one or more of a local intranet, a PAN (Personal Area Network), a LAN (Local Area Network), a WAN (Wide Area Network), a MAN (Metropolitan Area Network), a VPN (Virtual Private Network), or a SAN (storage area network). Furthermore, communications may also include links to any of a variety of wireless networks, including WAP (Wireless Application Protocol), GPRS (General Packet Radio Service), GSM (Global system for Mobile Communication), CDMA (Code Division Multiple Access) or TDMA (Time Division Multiple Access), cellular phone networks, GPS (Global Positioning System), CDPD (Cellular digit packet data), Bluetooth radio, or an IEEE 802.11 based radio frequency.

As can be appreciated, the network 130 can be a public network, such as the Internet, or a private network such as an LAN or WAN network, or any combination thereof and can also include PSTN or ISDN sub-networks. The network 130 can also be wireless such as a cellular network including EDGE, 3G and 4G wireless cellular systems. The wireless network can also be WiFi, Bluetooth, or any other wireless form of communication that is known. The network 130 can also communicate with an output device such as a printer and a display, which are controllable by the mobile device 110.

FIG. 1B shows an exemplary example of the support system 100 including a clinician 180 using the mobile device 110 with an integrated sensor 161 to sense one or more patient information 150 from a patient 170. Here, the lower half of a patient's leg is shown with a set of veins outlined. This example may be configured to be used in conjunction with carrier molecules such as in U.S. Pat. No. 7,087,724, the entire contents of which are herein incorporated by reference. The carrier molecules are used in a diagnostic application by an infrared imaging technique. In an example, the integrated sensor 161 is configured to sense a blood flow and to communicate the sensed blood flow data, representing the patient information 150, directly to the mobile device 110.

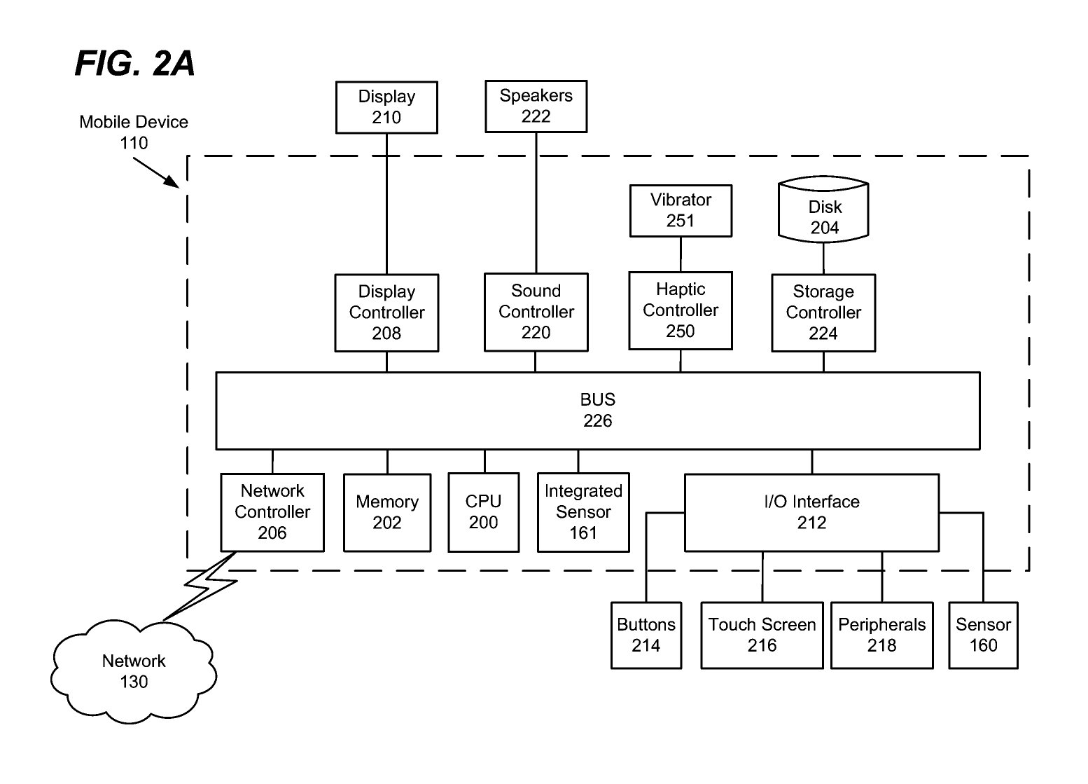

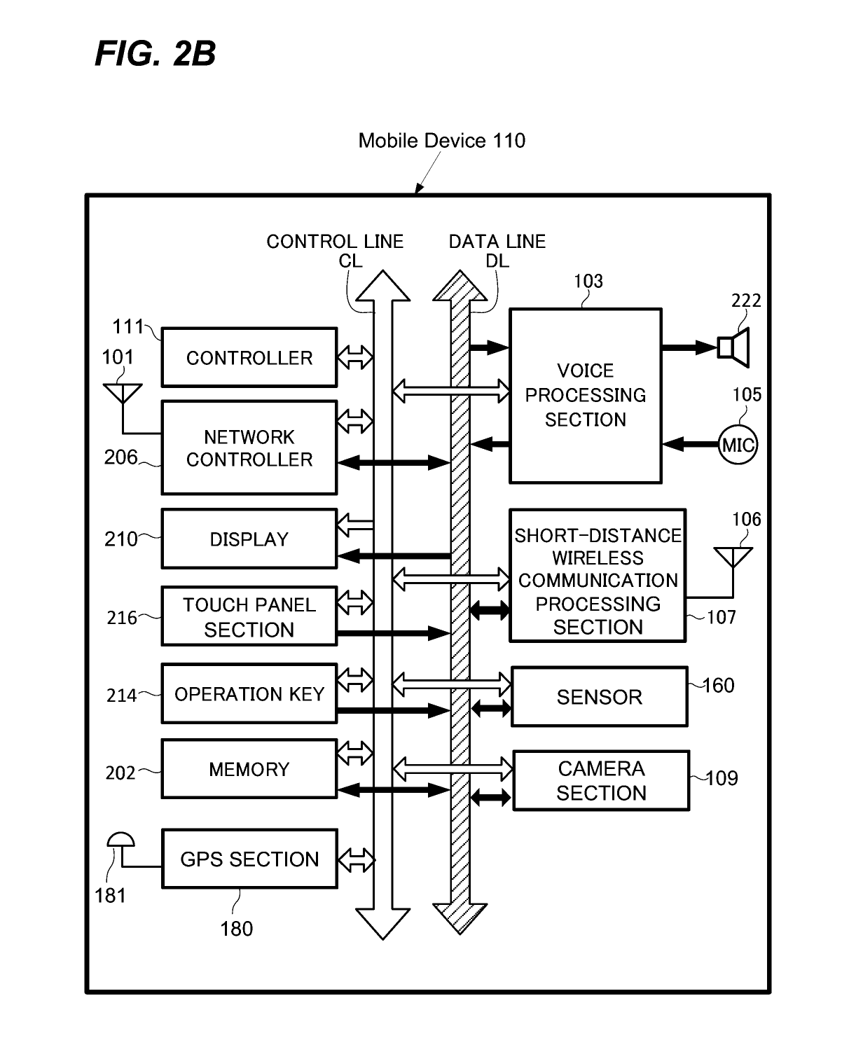

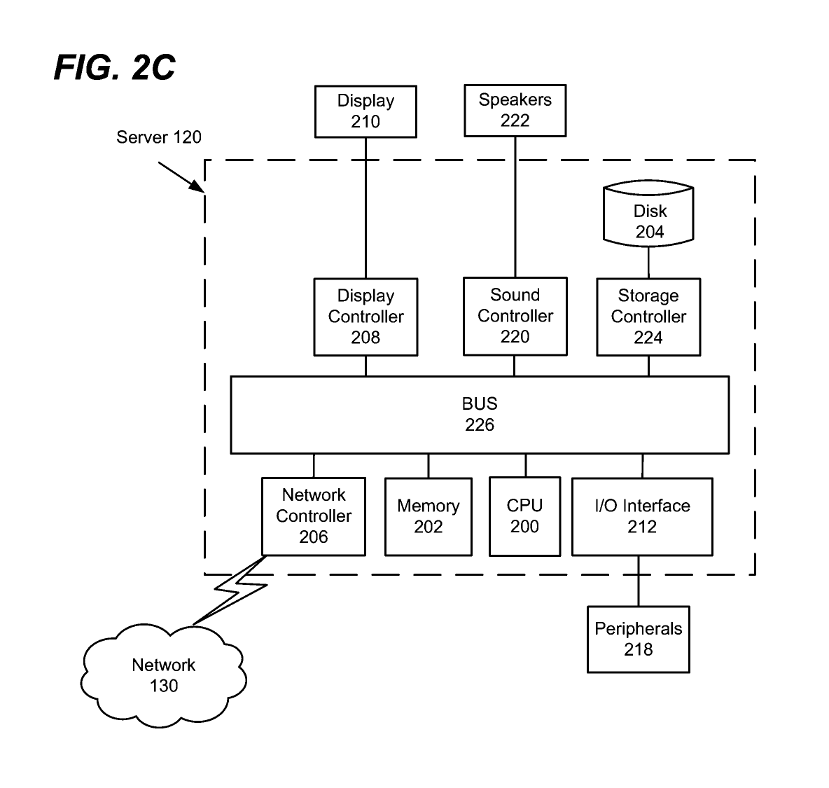

FIG. 2A is an exemplary block diagram of the mobile device 110 according to one example that can be used for implementing the features described herein. In FIG. 2A, the mobile device 110 includes a communication bus 226 (BUS), which may be an ISA, EISA, VESA, PCI, or similar, for interconnecting all components of the mobile device 110. The mobile device 110 includes a CPU 200 that performs the processes described above as well as those described herein in this application in combination or alone. Data and processing instructions are stored in memory 202. These processes and instructions may also be stored on a storage medium disk 204 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the mobile device 110 communicates, such as a server or a computer.

Further, the claimed advancements may be provided as a utility application, background daemon, or component of an operating system, or combination thereof, executing in conjunction with CPU 200 and an operating system such as Microsoft Windows 7, UNIX, Solaris, LINUX, Apple MAC-OS and other systems known to those skilled in the art.

The CPU 200 may be a Xenon or Core processor from Intel of America or an Opteron processor from AMD of America, or may be other processor types that would be recognized by one of ordinary skill in the art. Alternatively, the CPU 200 may be implemented on an FPGA, ASIC, PLD or using discrete logic circuits, as one of ordinary skill in the art would recognize. Further, the CPU 200 may be implemented as multiple processors cooperatively working in parallel to perform the instructions of the inventive processes described above.

The mobile device 110 in FIG. 2A also includes a network controller 206, such as an Intel Ethernet PRO network interface card from Intel Corporation of America, for interfacing with the network 130. The mobile device 110 further includes a display controller 208, such as a NVIDIA GeForce GTX or a Quadro graphics adaptor from NVIDIA Corporation of America for interfacing with a display 210. A general purpose I/O interface 212 interfaces with one or more operation keys 214 and a touch screen panel 216 on or separate from the display 210. The I/O interface 212 also connects to a variety of peripherals 218 including printers and scanners, such as an OfficeJet or DeskJet from Hewlett Packard. The I/O interface 212 also connects to the one or more sensors 160. The example including the integrated sensor 161 is shown here.

A sound controller 220 is also provided in the mobile device 110, such as Sound Blaster X-Fi Titanium from Creative, to interface with speakers/microphone 222 thereby providing sounds and/or music.

A haptic controller 250 and a vibrator 251 is also provided in the mobile device 110, and the haptic controller 250 is configured to provide different signal patterns, which create different vibrations by the vibrator 251.

The CPU 200 may be configured to operate as an alarm, whereby at least one of the display 210, the speakers 222, and the vibrator 251 are controlled to provide an alert.

A general purpose storage controller 224 connects the storage medium disk 204 with the communication bus 226. A description of the general features and functionality of the display 210, the speakers, as well as the display controller 208, the storage controller 224, the network controller 206, the sound controller 220, and the general purpose I/O interface 212 is omitted herein for brevity as these features are known.

The exemplary circuit elements described in context of the present disclosure may be replaced with other elements and structured differently than the examples provided herein. Moreover, circuitry configured to perform features described herein may be implemented in multiple circuit units (e.g., chips), or the features may be combined in the circuitry on a single chipset.

According to another example, the block diagram in FIG. 2A can be in part or in whole used to show the features of the system that can be used for implementing the features described herein by the server 120.

FIG. 2B is a detailed block diagram illustrating another example of a mobile device 110 according to an embodiment of the present disclosure. In certain embodiments, the mobile device 110 may be a smartphone. However, the skilled artisan will appreciate that the features described herein may be adapted to be implemented on other devices (e.g., a laptop, a tablet, a server, a camera, a navigation device, etc.). The mobile device 110 of FIG. 2B includes a controller 111 and the network controller 206 connected to an antenna 101. The speaker 222 and a microphone 105 are connected to a voice processor 103.

The controller 111 may include one or more Central Processing Units (CPUs), and may control each element in the mobile device 110 to perform functions related to communication control, audio signal processing, control for the audio signal processing, still and moving image processing and control, and other kinds of signal processing. The controller 111 may perform these functions by executing instructions stored in the memory 202. Alternatively or in addition to the local storage of the memory 202, the functions may be executed using instructions stored on an external device accessed on a network or on a non-transitory computer readable medium. The controller 111 may execute instructions allowing the controller 111 to function as the display controller 208.

The memory 202 includes but is not limited to Read Only Memory (ROM), Random Access Memory (RAM), or a memory array including a combination of volatile and non-volatile memory units. The memory 202 may be utilized as working memory by the controller 111 while executing the processes and algorithms of the present disclosure. Additionally, the memory 202 may be used for long-term storage, e.g., of image data and information related thereto.

The mobile device 110 includes a control line CL and data line DL as internal communication bus lines. Control data to/from the controller 111 may be transmitted through the control line CL. The data line DL may be used for transmission of voice data, display data, etc.

The antenna 101 transmits/receives electromagnetic wave signals between the network controller 206 and the network 130. The network controller 206 controls communication performed between the mobile device 110 and other external devices via the antenna 101. For example, the network controller 206 may control communication between base stations for cellular phone communication.

The speaker 222 emits an audio signal corresponding to audio data supplied from the voice processor 103. The microphone 105 detects surrounding audio and converts the detected audio into an audio signal. The audio signal may then be output to the voice processor 103 for further processing. The voice processor 103 demodulates and/or decodes the audio data read from the memory 202 or audio data received by the network controller 206 and/or a short-distance wireless communication processor 107. Additionally, the voice processor 103 may decode audio signals obtained by the microphone 105.

The mobile device 110 in this example may also include the display 210, the touch panel 216, the one or more operation keys 214, and a short-distance communication processor 107 connected to an antenna 106. The display 210 may be a Liquid Crystal Display (LCD), an organic electroluminescence display panel, or another display screen technology. In addition to displaying still and moving image data, the display 210 may display operational inputs, such as numbers or icons which may be used for control of the mobile device 110. The display 210 may additionally display a GUI for a user to control aspects of the mobile device 110 and/or other devices. Further, the display 210 may display characters and images received by the mobile device 110 and/or stored in the memory 202 or accessed from an external device on a network. For example, the mobile device 110 may access a network such as the Internet and display text and/or images transmitted from a Web server.

The touch panel 216 may include a physical touch panel display screen and a touch panel driver. The touch panel 216 may include one or more touch sensors for detecting an input operation on an operation surface of the touch panel display screen. The touch panel 216 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 216 may detect when the stylus approaches/contacts the operation surface of the touch panel display (similar to the case in which a finger is used for the touch operation). In certain aspects of the present disclosure, the touch panel 216 may be disposed adjacent to the display 210 (e.g., laminated) or may be formed integrally with the display 210. For simplicity, the present disclosure assumes the touch panel 216 is formed integrally with the display 210 and therefore, examples discussed herein may describe touch operations being performed on the surface of the display 210 rather than the touch panel 216. However, the skilled artisan will appreciate that this is not limiting.

For simplicity, the present disclosure assumes the touch panel 216 is a capacitance-type touch panel technology. However, it should be appreciated that aspects of the present disclosure may easily be applied to other touch panel types (e.g., resistance-type touch panels) with alternate structures. A touch panel driver may be included in the touch panel 216 for control processing related to the touch panel 216.

The operation key 214 may include one or more buttons or similar external control elements, which may generate an operation signal based on a detected input by the user. In addition to outputs from the touch panel 216, these operation signals may be supplied to the controller 111 for performing related processing and control. In certain aspects of the present disclosure, the processing and/or functions associated with external buttons and the like may be performed by the controller 111 in response to an input operation on the touch panel 216 display screen rather than the external button, key, etc. In this way, external buttons on the mobile device 110 may be eliminated in lieu of performing inputs via touch operations, thereby improving water-tightness.

The antenna 106 may transmit/receive electromagnetic wave signals to/from other external apparatuses, and the short-distance wireless communication processor 107 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 107.

In one example, the mobile device 110 may include a camera section 109, which includes a lens and shutter for capturing photographs of the surroundings around the mobile device 110. In an embodiment, the camera section 109 captures surroundings of an opposite side of the mobile device 110 from the user. The images of the captured photographs can be displayed on the display panel 210. A memory section saves the captured photographs. The memory section may reside within the camera section 109 or it may be part of the memory 202. The camera section 109 can be a separate feature attached to the mobile device 110 or it can be a built-in camera feature.

The GPS section 180 detects the present position of the mobile device 110. The information of a present position detected by the GPS section 180 is transmitted to the controller 111. An antenna 181 is connected to the GPS section 180 for receiving and transmitting signals to and from a GPS satellite.

FIG. 2C is an exemplary block diagram of the server 120 according to one example. The server 120 is shown including similar components as the mobile device for communication and processing. In one embodiment, the processing of the methods described herein, as well as the processing of the sensor data are done by the server 120. After processing by the server, the results are communicated back to the mobile device 110.

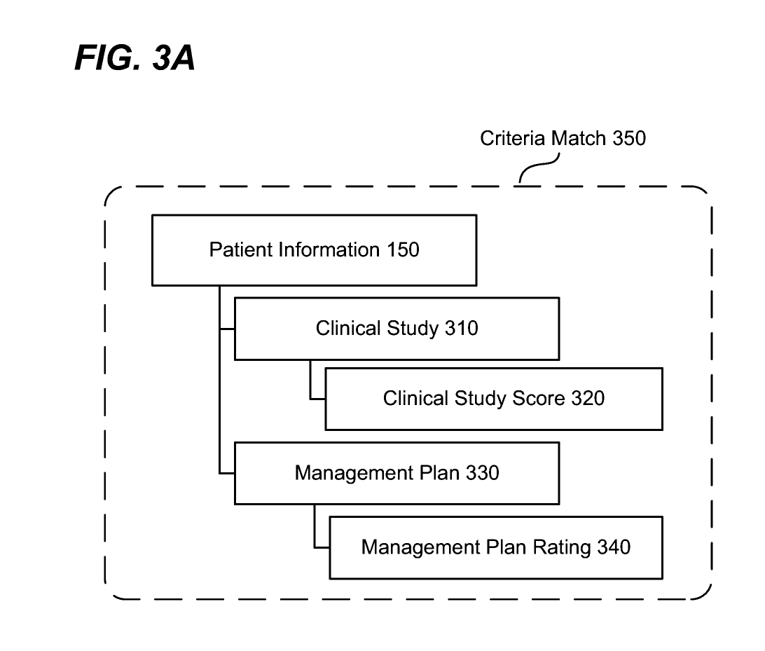

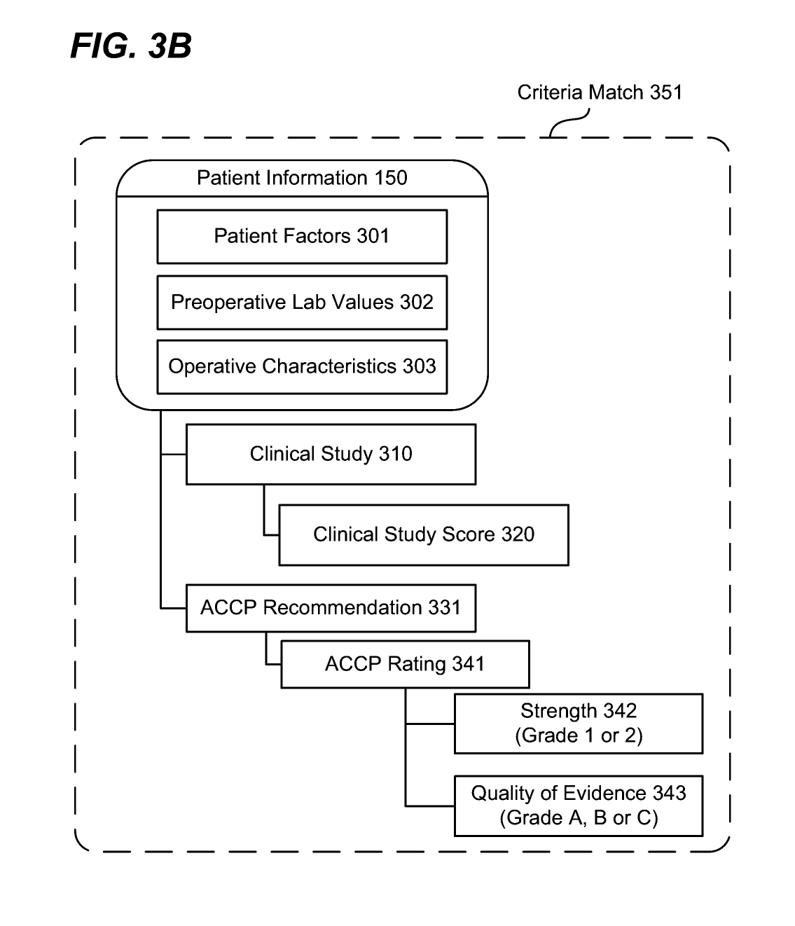

FIG. 3A shows an example of a criteria match 350, which is a match between a set of one or more patient information 150 to one or more applicable clinical studies 310 and a management plan 330. The management plan 330 or medical management plan is a set of evidence-based clinical practice guidelines including recommendations for the prevention, diagnosis, and treatment of medical diseases and conditions. Each management plan 330 has a management plan rating 340, which is a set of ratings indicating the qualification of the respective management plan 330. In an example, the management plan rating 340 includes a rating strength and a rating quality of evidence.

In an example, each clinical study 310 has a clinical study score 320 and each management plan 330 has a management plan rating 340. A plurality of unique criteria matches 350 exist for all applicable set of patient information 150 to a matching applicable clinical study 310 and a applicable management plan 330.

The patient information 150 includes qualitative and quantitative information, and is categorized in several ways, in an example. The patient information 150 may be categorized as a set of patient factors, a set of preoperative laboratory values, and a set of operative characteristics. The patient information 150 may include patient past, present, or future conditions such as pregnancy, and mode of delivery such as caesarian section, and a renal status.

The clinical study 310 includes any clinical study related to the management plan 330. In an example, the clinical study 310 includes the clinical study score 320. In another example the clinical study score 320 can be provided by the management plan 330 and the management plan rating 340. The clinical study 310 becomes applicable when the patient information 150, used in the respective clinical study 310, are known.

The clinical study score 320 is the corresponding clinical study's 310 own scoring system for the recommendations and outcomes of the study. The scoring system can be quantitative or qualitative or a combination. In case the scoring system had qualitative or incomplete information, further distinctions and groupings can be used to distinguish the clinical study 310 outcomes. An alert system will alert clinician to complete missed data.

Further details may be incorporated in the management plan 330 and the management plan rating 340 that were not considered in the clinical studies 310 and the clinical study scores 320. For example, certain patient information 150 may have been provided in the clinical study 310 or later discovered and associated with the clinical study 310 that were not factored in the respective clinical study score 320. This patient information 150 is considered as part of the patient information 150 associated with the clinical study 310. Examples of the patient information 150 that is considered relevant includes a location and a travel history of the patient 170 corresponding with the patient information 150 in the clinical study 310.

FIG. 3B shows the support system 100 in one example with a criteria match 351, wherein the management plan 330 is adapted for the prevention, diagnosis, and treatment of thrombosis in a surgical setting. DVT and PE thrombosis describes a formation of a blood clot inside a blood vessel of a patient's body that obstructs a flow of blood through the circulatory system. A blood clot that travels around the body is known as an embolus. A thromboembolism is the combination of thrombosis and the traveling embolism and is a potentially fatal condition. Thromboembolisms may cause strokes and myocardial infarctions, resulting in sudden death, paralysis, neurological damage or other irreversible tissue damage. There are numerous different causes and conditions producing symptoms of thrombosis in patients. Patients with different backgrounds or those with comorbidities require varying diagnosis methods, treatment plans, and prophylactic strategies. While, thrombosis is a medical risk that has a higher risk profile for patients having certain risk factors, the risk is present in patients of all socioeconomic classes and comorbidities with time sensitivities. Therefore, a clinician's discretion is often used to balance the benefits, risks, burdens, and costs of intervention.

An example of the management plan 330 for thrombosis is a American College of Chest Physicians (ACCP) Recommendation 331, which is a guide to the clinician on how to treat venous thromboembolism using different anticoagulants including un-fractionated heparins, low molecular weight heparins and warfarins in a step by step fashion. The ACCP Recommendation 331 is provided by a publication by the American College of Chest Physicians, herein incorporated in its entirety, and is cited as Kearon C, Akl E A, Comerota A J, Prandoni P, Bounameaux H, Goldhaber S Z, Nelson M E, Wells P S, Gould M K, Dentali F, Crowther M, Kahn S R. Antithrombotic therapy for VTE disease: antithrombotic therapy and prevention of thrombosis, 9th ed: American College of Chest Physicians evidence-based clinical practice guidelines, Chest, 2012 February; 141, 2 Suppl:e419S-94S. The ACCP Recommendation 331 includes more than six hundred recommendations for prevention, diagnosis, and treatment of thrombosis; addressing a comprehensive list of clinical conditions, including medical, surgery, orthopedic surgery, atrial fibrillation, stroke, cardiovascular disease, pregnancy, and neonates and children.

In the case where the management plan 330 is the ACCP Recommendation 331, the management plan rating 340 is a ACCP rating 341. The ACCP rating 341 indicates a qualification of the ACCP recommendation 331 and is provided by a report by Guyatt G, Gutterman D, Baumann M, et al., “Grading strength of recommendations and quality of evidence in clinical guidelines: report from an American College of Chest Physicians task force,” Chest, 2006, 129, 1, 174-181, herein incorporated in its entirety. The ACCP rating 341 includes a ACCP rating strength 342 and a ACCP rating quality of evidence 343.

The ACCP rating strength 342 classifies the ACCP Recommendation 331 as strong or weak, “grade 1” or “grade 2” respectively, according to a balance among benefits, risks, burdens, and cost, and a degree of confidence in estimates of benefits, risks, and burdens.

The ACCP rating quality of evidence 343 classifies the ACCP Recommendation 331 by the quality of evidence as high, moderate, and low, or “grade A,” “grade B,” and “grade C” respectively, according to factors including design of the clinical study 310, consistency of the study results, and directness of the evidence.

The ACCP rating 341 relies on multiple independent clinical studies 310, most of them having a respective clinical study score 320 for determining risk assessments relating to thrombosis.

The ACCP Recommendations 331 and the ACCP ratings 341 for the prevention and treatment of thrombosis are based on one or more clinical studies 310 having their own respective clinical study scoring systems for determining risk assessments including a Padua scoring system, a Caprini scoring system, a Khorana scoring system, and a CHADS2 scoring system.

The Padua scoring system is typically used for hospitalized medical patients and further details are described by the publication: Barbar, S. et al. A risk assessment model for the identification of hospitalized medical patients at risk for venous thromboembolism: the Padua Prediction Score, Journal of Thrombosis and Haemostasis, 2010, 8: 2450-2457, herein incorporated by reference.

The Khorana scoring system is typically used for cancer patients and further details are described by the publication: Khorana A A, Kuderer N M, Culakova E, et al. Development and validation of a predictive model for chemotherapy associated thrombosis, Blood, 2008 111:4202-7, herein incorporated by reference.

The Caprini scoring system is typically used for surgical patients and further details are described by the publication: Caprini J A, Risk assessment as a guide to thrombosis prophylaxis, Curr Opin Pulm Med. 2010 September; 16, 5, 448-52, herein incorporated by reference.

The CHADS2 scoring system is provided in Table 1.

TABLE 1

| | Condition | Points |
|---|---|---|
| C | Congestive heart failure | 1 |
| H | Hypertension: blood pressure consistently above | 1 |
| | 140/90 mmHg (or treated hypertension on | |
| | medication) | |
| A | Age ≥75 years | 1 |
| D | Diabetes Mellitus | 1 |
| S₂ | Prior Stroke or TIA or thromboembolism | 2 |

The scoring systems may be updated and supplemented with additions of new clinical studies 310 and revisions to the management plan 330. For example, a CHA2DS2-VASc score is an alternate version of the CHADS2 scoring system and is provided in Table 2.

TABLE 2

| | Condition | Points |
|---|---|---|
| C | Congestive heart failure (or Left ventricular | 1 |
| | systolic dysfunction) | |
| H | Hypertension: blood pressure consistently above | 1 |
| | 140/90 mmHg (or treated hypertension on | |
| | medication) | |
| A₂ | Age ≥75 years | 2 |
| D | Diabetes Mellitus | 1 |
| S₂ | Prior Stroke or TIA or thromboembolism | 2 |
| V | Vascular disease (e.g. peripheral artery disease, | 1 |
| | myocardial infarction, aortic plaque) | |
| A | Age 65-74 years | 1 |
| Sc | Sex category (i.e. female sex) | 1 |

It is important to note the distinctions between respective elements in Table 1 and Table 2. Specifically, a factor of age is further distinguished in the CHA2DS2-VASc scoring system and has a different point value attributed to it compared to the CHADS2 scoring system.

Examples of the patient information 150 include variables independently associated with increased risk of DVT and PE, including a set of patient factors 301, a set of preoperative laboratory values 302, and a set of operative characteristics 303. The patient factors 301 include a female gender, a higher American Society of Anesthesiologists class, a ventilator dependence, preoperative dyspnea, disseminated cancer, chemotherapy within 30 days, and >4 U packed red blood cell transfusion in the 72 hours before an operation. The preoperative laboratory values 302 include albumin <3.5 mg/dL, bilirubin >1.0 mg/dL, sodium >145 mmol/L, and hematocrit <38%. The operative characteristics 303 include the type of surgical procedure, emergency operation, work relative value units, and presence infected/contaminated wounds.

The patient information 150 used to determine the diagnostic criteria for a DVT and PE includes clinical criteria, D-dimer testing, and radiological testing. An example of clinical criteria related to thrombosis is provided by the publication: Wells P S, Anderson D R, Rodger M, Ginsberg J S, Kearon C, Gent M, Turpie A G, Bormanis J, Weitz J, Chamberlain M, Bowie D, Barnes D, Hirsh J. Derivation of a simple clinical model to categorize patients probability of pulmonary embolism: increasing the models utility with the SimpliRED Ddimer. Thromb Haemost. 2000 March; 83, 3, 416-20; and Wells P S, Anderson D R, Bormanis J, Guy F, Mitchell M, Gray L, Clement C, Robinson K S, Lewandowski B. Value of assessment of pretest probability of deep-vein thrombosis in clinical management. Lancet. 1997 Dec. 20-27; 350, 9094, 1795-8, herein both incorporated in their entirety. An example of D-dimer testing related to thrombosis is provided by the publication: Prisco D1, Grifoni E. The role of D-dimer testing in patients with suspected venous thromboembolism. Semin Thromb Hemost. 2009 February; 35, 1, 50-9, herein incorporated in its entirety. An example of radiological testing related to thrombosis is provided by the publication: Schutgens R E, Ackerman P, Hass F J, et al. Combination of a normal D-dimer concentration and non-high probability score is a safe strategy to exclude deep venous thrombosis. Circulation. 2003; 107:593-9, herein incorporated in its entirety.

In one example, the patient information 150 is a result of a calculation done on the mobile device 110. For example, testing the Well's criteria includes a calculation based on a patient's clinical data. The results of a D-Dimer lab test is communicated to the mobile device 110 and the calculations are done using the CPU 200.

As the examples above demonstrate, the clinician 180 is provided an intervention recommendation based on one or more selections of clinical studies 310 that vary in scope, strength, and conclusions. Each of these clinical studies 310 take into account different patient information 150 and assign them different levels of importance resulting in unparalleled comparisons from one study to another. In addition, each type of patient information 150 may differ in accessibility and timeliness. Therefore, the clinician 180 must prioritize obtaining patient information 150 according to several factors including their associated benefits, risks, burdens, and costs.

For example, the first set of known patient information includes history of: chronic heart failure (CHF), hypertension, age >75 years, diabetes mellitus, and prior stroke/TIA. Genetic factors including variations in antithrombin, protein C, or protein S deficiencies are associated with approximately 5 to 10 fold, 4 to 6 fold and 1 to 10 fold increased risk of VTE respectively. However, genetic testing is costly. A patient with history resulting in a CHADS-VASc score=0 suggests that other clinical or laboratory factors may not have significant contribution to thromboembolic risk.

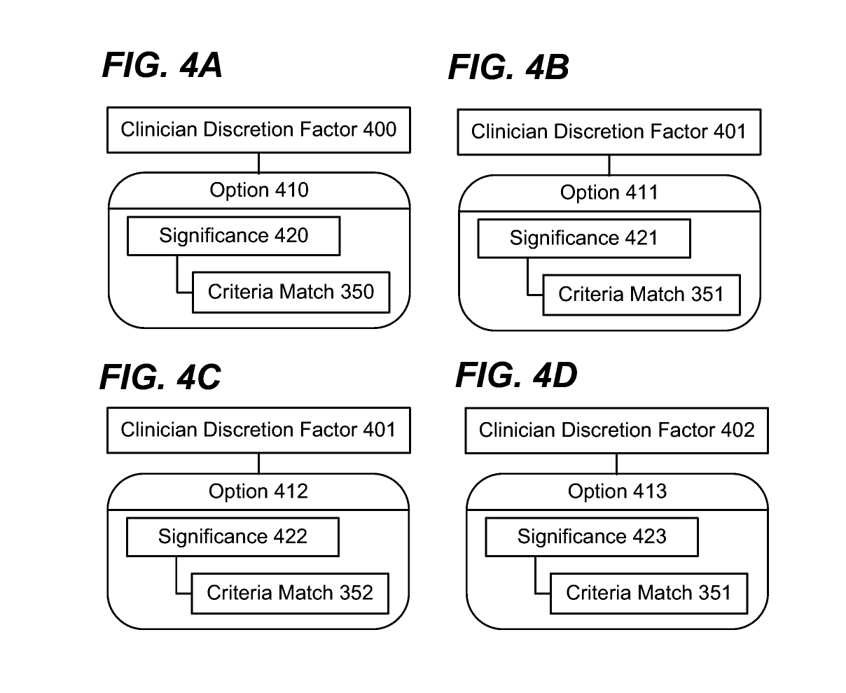

FIG. 4A shows an exemplary example of a relationship between a clinician discretion factor 400, which may influence a treatment plan, and one or more weighted options 410 each having a significance value or significance 420 corresponding to the respective criteria match 350.

The clinician discretion factor 400 is an input to the support system 100 defining a set of criteria matches 350. Examples of the clinician discretion factors 400 include emphasizing one or more medical factors, such as emphasizing potential contraindications to the treatment or the patient's renal functions, as well as factors that may influence a drug's effect. In another example, the clinician discretion factors 400 include factors such as timeliness, resources, required and cost of obtaining the patient information 150. A patient's age and a patient's compliance to the clinician's order are also factors that the clinician 180 takes into consideration. In an example, the timeliness of obtaining the patient information 150 is an important factor in the management plan 330 for mitigating potential risk factors for contraindications with time-sensitive comorbidities, such as in the case of a pulmonary embolism. The cost of obtaining patient information 150 may be important for the patients that can't afford optimal care. The clinician discretion factor 400 is used to consider balance among benefits, risks, burdens, and costs, and degree of confidence in estimates of the benefits, risks, burdens, and costs. In another example, when more than one clinician discretion factor 400 is selected, combination of both factors is considered as one clinician discretion factor 400 for determination of the one or more weighted options 410.

The significance 420 reflects a statistical probability that the unknown patient information 150 will make a currently inapplicable clinical study 310 applicable, resulting in an increase of the set of clinical study scores 320, or an increase the management plan rating 340 of the existing or a respective new management plan 330, while factoring the clinician discretion factor 400.

When the clinician discretion factor 400 is input into the support system 100, the one or more weighted options 410 will generate in an organized manner as related to the clinician discretion factor 400. Each weighted option 410 includes the significance 420 corresponding to the respective criteria match 350. As an example, if the clinician discretion factor 400 is timeliness, the timeliness for obtaining the associated patient information 150 to meet the respective criteria match 350, and the one or more weighted options 410 are presented in the order of the significance 420, indicating one of the absolute and relative time to obtain the respective criteria match 350. As another example, if the clinician discretion factor 400 is cost, the cost is calculated for obtaining the associated patient information 150 to meet the respective criteria match 350, and the one or more weighted options 410 are presented in the order of the significance 420, indicating one of the absolute and relative cost to obtain the respective criteria match 350.

Together, FIG. 4B-FIG. 4D show an exemplary example of a unique relationship between the clinician discretion factor 400, the weighted option 410, the significance 420, and the criteria match 350.

FIG. 4B shows an exemplary example of a relationship between a first clinician discretion factor 401, resulting in a respective first weighted option 411 having a respective first significance 421, which corresponds to a first respective criteria match 351. FIG. 4C shows an exemplary example of a relationship between the first clinician discretion factor 401, resulting in a respective second weighted option 412 having a respective second significance 422, which corresponds to a respective second criteria match 352. FIG. 4D shows an exemplary example of a relationship between a second clinician discretion factor 402, resulting in a third weighted option 413 having a respective third significance 423, which corresponds to the respective criteria match 351.

Comparing examples in FIG. 4B and FIG. 4C, the identical clinician discretion factor 401 resulted in two weighted options 411, 412 with different sets of significance 421, 422 for different sets of criteria matches 351, 352. Next, comparing examples in FIG. 4C and FIG. 4D, different clinician discretion factors 401, 402 resulted in two weighted options 412, 413 with different sets of significance 422, 423 for different sets of corresponding criteria matches 352, 351. This result is straight forward. Finally, comparing examples in FIG. 4B and FIG. 4D, different clinician discretion factors 401, 402 resulted in two respective weighted options 411, 413 having different sets of significance 421, 423 for the same set of criteria match 351. This example is unique and indicates functionality of the clinician discretion factor 400 and how the significance 420 can result in different values despite meeting the same criteria match 350.

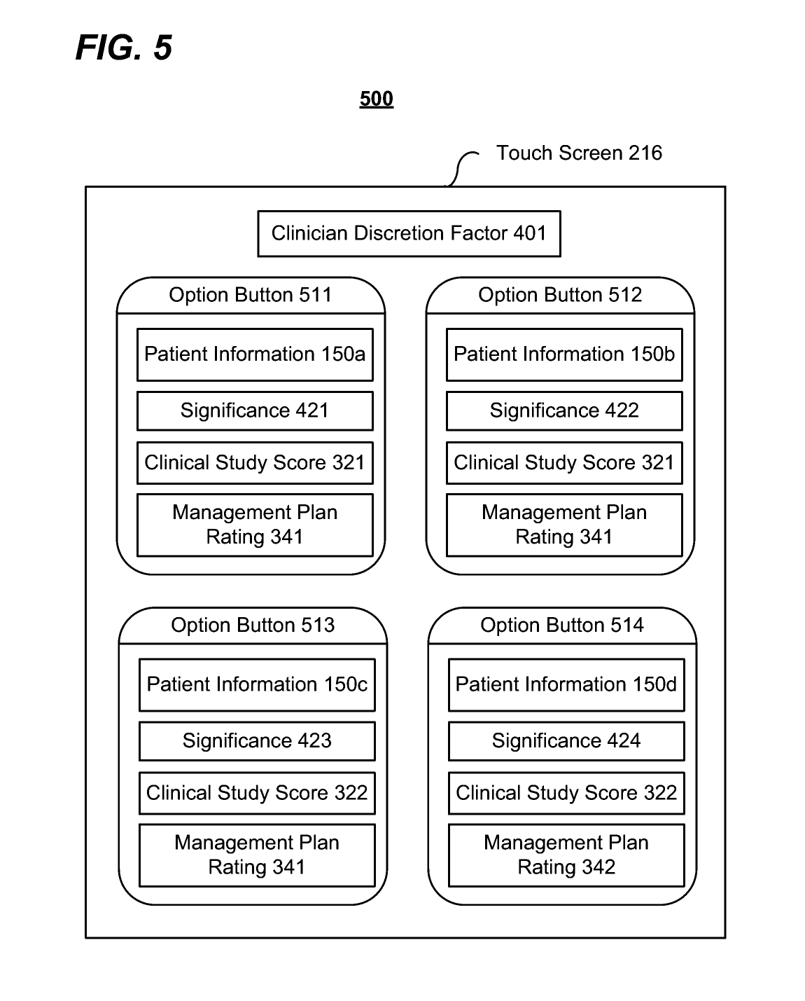

FIG. 5 illustrates an example of a discretion process result 500 displayed on the touch screen 216 of the mobile device 110 showing an example of the clinician discretion factor 401 that was selected and the one or more option buttons 510, here 511-514. The option buttons 511-514 each represent an example of the unknown patient information 150 having the associated significance 420, the clinical study score 320, and the management plan rating 340, based on the one or more weighted options 410 as identified in FIG. 4A-FIG. 4D. Each option button 510 has unique values for the significance 420 based on the weighting of the clinician discretion factor 400. Within each option button 510, the clinician is provided with analysis relating to the resources and requirements to obtain the respective unknown patient information, as well as the significance that patient information may have on improving the certainty of the clinical study score 230 and the strength of the management plan rating 340. In this example, the clinician can quickly observe the statistical importance of the different cases of the unknown patient information.

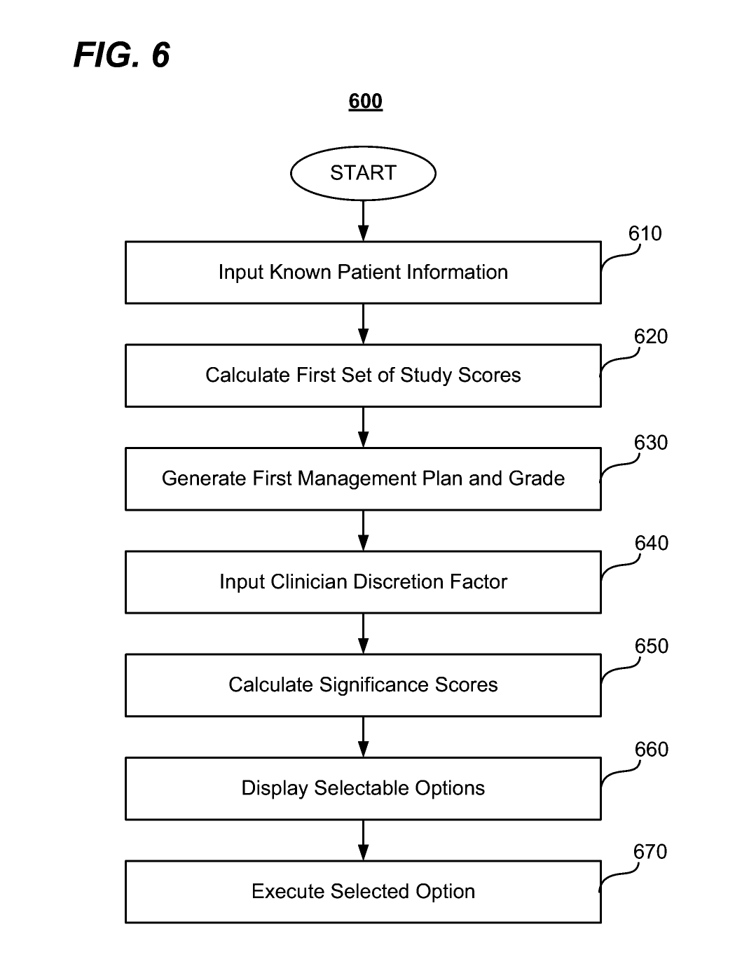

As described in the process in FIG. 6, selection of the option button 510 executes a clinical order to obtain the respective unknown patient information 150. Examples of a clinical order to obtain the respective patient information 150 include sending a lab test request to the EMR system for a clinical staff member to fulfill. In another example, the EMR can work with other 3^{rd} party scheduling systems to create the clinical order.

FIG. 6 illustrates an exemplary algorithmic flowchart 600 for performing the interactive clinical decision making method according to an example. The hardware description above, exemplified by any one of the structure examples shown in FIG. 1A, FIG. 1B, FIG. 2A, FIG. 2B, or FIG. 2C constitute or include a specialized corresponding structure that is programmed or configured to perform the steps shown in FIG. 6. As these functions are not well known or conventional, the hardware represents a non-generic specially programmed hardware programmed to perform novel features. An interactive method of clinical decision making includes the following processes or steps in one example.

Initial step 610 includes inputting known or a first set of patient information 150. In one example, the input is done manually by entering information in the I/O Interface 212. In another example, the input is done by downloading the patient information 150 from the EMR or any other peripheral device having the patient information 150, including inputting the patient information 150 from the one or more sensors 160 and the integrated sensor 161. For example, the first set of patient information 150 may include observed patient vitals by the clinician and reported patient symptoms such as pain and nausea. The second set of patient information 150 may include the results from a D-Dimer blood test. The third set of patient information may include sensor data from the scan of the leg.

Step 620 includes calculating a first set of clinical study scores 320 based on the first set of available patient information 150 and the first set of applicable clinical studies 310. In an exemplary example, the calculations include a combination of logical comparison trees for determining patient stratification and quantification of lab test information. In an example, a platelets calculation is calculated for a patient on heparin therapy, whereby the CPU 200 triggers an alarm for possibility of heparin-induced thrombocytopenia, which is a fatal complication of heparin therapy.

At step 630 a first management plan 330 and a first management plan rating 340 are generated. In the case that there is incomplete information to generate the management plan 330, the method will advance to step 640.

At step 640 a first clinician discretion factor 400 is received for determining the priority of the significance 420 of each weighted option 410.

At step 650 calculations are done producing a plurality of the significance 420 scores of a plurality of unknown patient information 150 based on the clinician discretion factor 400.

At step 660 the one or more option buttons 510 of the unknown patient information 150 are displayed in order according to the clinician discretion factor 400 and the significance 420. As shown in this example, the displayed option buttons 511-514 may further include indications of the significance 420, here 421-424, for different clinician discretion factors 400, here 401. As shown in this example, selected elements from the weighted options 410 and the respective significance 420 values are displayed or indicated within the option buttons 510 on the touch screen 216 of the mobile device 110. Displaying of the option buttons 510 is done in a variety of ways including in an arrangement in a hierarchy table. The table is ordered in a variety of ways including from top to bottom and left to right. Alternatively, the option buttons 510 may be shown on the display 210 and the one or more operation keys 214 on the mobile device 101 are used to indicate selections. In another example, the set of patient information 150 is displayed in a fixed arrangement with enumerating indications reflecting the significance 420, such as numbering, coloring, and other differentiating methods. In addition, each patient information 150 displayed may have different indications for each significance 420 corresponding to each clinician discretion factor 400.

In another example, more than one clinician discretion factor 400 is selected and the combination of both factors are considered for determination of the significance 420 and the order of displaying.

At step 670 selection of the option button 510 executes a clinical order to obtain the respective patient information 150, and the process is repeated at step 610.

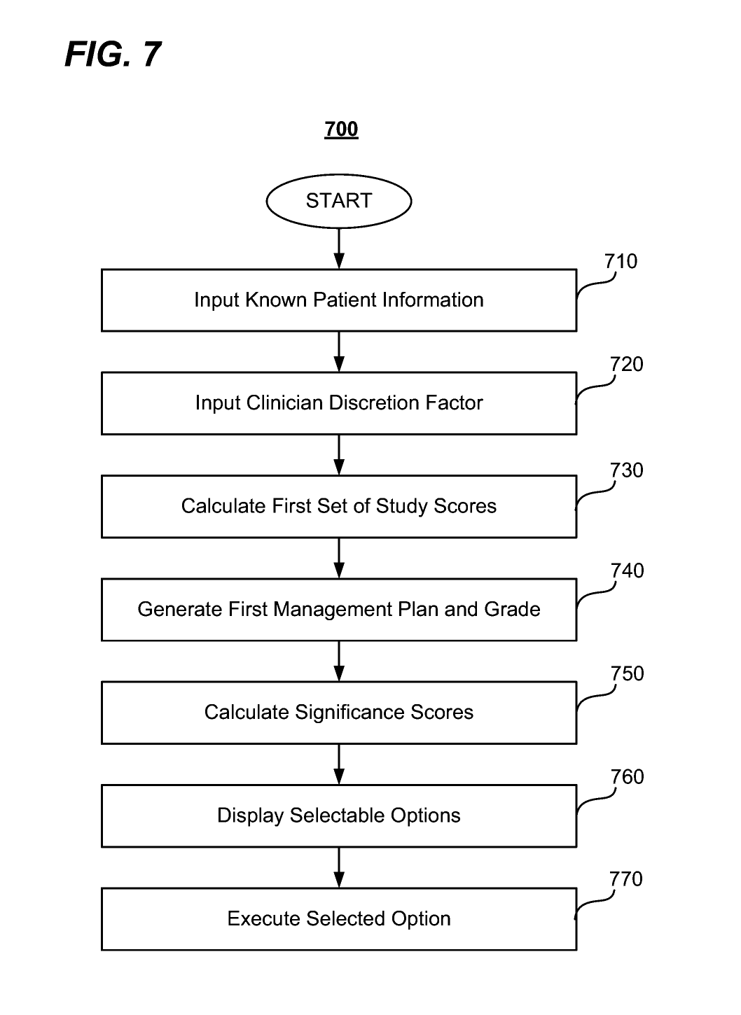

FIG. 7 illustrates an exemplary algorithmic flowchart 700 for performing the interactive clinical decision making method according to an example. The hardware description above, exemplified by any one of the structure examples shown in FIG. 1A, FIG. 1B, FIG. 2A, FIG. 2B, or FIG. 2C constitute or include a specialized corresponding structure that is programmed or configured to perform the steps shown in FIG. 7. An interactive method of clinical decision making for thrombosis diagnosis, management, and prophylaxis includes the following processes or steps in an example.

Initial step 710 includes inputting a known or a first set of patient information 150. In one example, the input is done manually by entering information in the I/O Interface 212. In another example, the input is done by downloading the patient information 150 from the EMR or any other peripheral device having the patient information 150, including inputting the patient information 150 from the one or more sensors 160 and the integrated sensor 161.

At step 720 the first clinician discretion factor 400 is input manually into the mobile device 110 or is communicated by the server 120.

Step 730 includes calculating a first set of clinical study scores 320 based on the first set of available patient information 150, the first set of applicable clinical studies 310, and the clinician discretion factor 400.

At step 740 a first management plan 330 and a first management plan rating 340 is generated base on the patient information 150, the clinician discretion factor 400, and the first set of applicable clinical studies 310. In the case that there is incomplete information to generate the management plan 330, the method will advance to step 760.

At step 750 a plurality of the significance 420 scores of a plurality of unknown patient information 150 based on the clinician discretion factor 400 is calculated.

Similar to step 660, at step 760, the one or more option buttons 510 of the unknown patient information 150 are displayed in priority according to the clinician discretion factor 400 and the significance 420.

Similar to step 670, at step 770, a selection of the option button 510 executes a clinical order to obtain the respective patient information 150, after which the process is repeated at step 710.

Advantages of the system and methods described here can be applied to any healthcare system that combines objective patient data, limited resources, and pragmatic decision factors. Healthcare is a unique field where new discoveries and evidence based medicine are being made daily yet are not accessible evenly to all clinicians. The mobile device including a sensor for taking in new patient information automatically processes the sensed data and restarts the process. Furthermore, other factors that require pragmatic consideration such as clinical resources, timing, and costs of care can now be considered in the clinical decision making process to inform the clinician of their significance. The system and methods described here allow for up to date and informed decision making which relies on large number of rules, varying scoring systems, and simultaneous sensing and computations.

Obviously, numerous modifications and variations of the present invention are possible in light of the above teachings. It is therefore to be understood that within the scope of the appended claims, the invention may be practiced otherwise than as specifically described herein.

1. An interactive clinical decision support apparatus comprising:
a memory configured to store one or more electronic medical records having a set of patient information; and
circuitry configured to:
receive a clinician discretion factor,
access a database including one or more clinical studies and one or more medical management plans,
process the set of patient information, the clinician discretion factor, the one or more clinical studies, and the one or more medical management plans,
generate, as a function of the patient information, the clinician discretion factor, the one or more clinical studies, and the one or more medical management plans, a set of selections for requesting a clinical order to obtain new patient information, wherein the selections are ordered according to a significance value calculated using the clinician discretion factor, and
transmit the set of ordered selections to an external device, the transmission activating an application on the external device to cause the set of ordered selections to display on the external device.

2. The apparatus of claim 1, wherein the circuitry is configured to receive at least part of the patient information from one or more hardware sensors configured to sense the patient information.

3. The apparatus of claim 2, wherein one of the sensors is an infrared imaging sensor.

4. The apparatus in claim 1, wherein the circuitry is further configured to generate the set of selections as a function of one or more clinical study scores.

5. The apparatus in claim 1, wherein the circuitry is further configured to generate the set of selections as a function of one or more management plan scores.

6. The apparatus in claim 1, wherein one of the medical management plans is a medical management plan having a set of American College of Chest Physicians (ACCP) Recommendations for deep venous thrombosis and pulmonary embolism diagnosis, management, and prophylaxis.

7. The apparatus in claim 1, wherein one of the clinical studies includes a Well's criteria.

8. The apparatus in claim 1, wherein the significance value for each selection calculated using the clinician discretion factor reflects a statistical chance that the respective patient information affects one of the one or more clinical study scores or the one or more management plan scores.

9. The apparatus in claim 1, wherein the circuitry is further configured to
receive a preferred selection from the external device, and
process a respective clinical order to obtain new patient information by adding the clinical order to an electronic schedule or alerting a clinical staff to perform a task.

10. The apparatus in claim 2, wherein the circuitry is further configured to activate one or more hardware sensors on the external device to obtain the new patient information.

11. The apparatus in claim 1, wherein the circuitry is further configured to activate an alarm on the external device based on the processing.

12. The apparatus in claim 1, wherein the circuitry is further configured to
generate, parallel sets of selections for requesting a clinical order to obtain new patient information, wherein each set of selections is based on a significance value calculated using a different clinician discretion factor, and
transmit the parallel sets of ordered selections to the external device, the transmission activating the application on the external device to cause the parallel set of ordered selections to display on the external device,
wherein the parallel set of ordered selections are displayed on the external device such that all of the calculated significance values for each unknown patient information are displayed together with indicators for their respective clinician discretion factor.

13. The apparatus in claim 1, wherein the circuitry is further configured to generate, based on the significance value calculated using a combination of two or more clinician discretion factors, a set of selections for requesting a clinical order to obtain new patient information.

14. An interactive method of clinical decision making, the method comprising:
receiving a first set of patient information and a clinician discretion factor;
accessing a database including one or more clinical studies and one or more medical management plans;
processing a set of patient information, the clinician discretion factor, the one or more clinical studies, and the one or more medical management plans;
generating, via processing circuitry and as a function of the patient information, the clinician discretion factor, the one or more clinical studies, and the one or more medical management plans, a set of selections for requesting a clinical order to obtain new patient information, wherein the selections are ordered according to a significance value calculated using the clinician discretion factor; and
transmitting the set of ordered selections to an external device, the transmission activating an application on the external device to cause the set of ordered selections to display on the external device.

15. The interactive method of clinical decision making of claim 14, the method further comprising:
receiving a preferred selection from the external device, and
processing a respective clinical order to obtain new patient information by adding the clinical order to an electronic schedule or alerting a clinical staff to perform a task.

16. The interactive method of clinical decision making of claim 14, wherein the processing step includes identifying the set of patient information that matches each clinical study and each medical management plan, and identifying a set of unknown patient information that completes a match for each clinical study and each medical management plan.

17. An system for interactive clinical decision making, the system comprising:
a database configured to store one or more electronic medical records having a set of patient information, one or more clinical studies, and one or more medical management plans;
a mobile device;
a network; and
a server configured to:
receive, via the network, a clinician discretion factor,
access, via the network, the database,
process the set of patient information, the clinician discretion factor, the one or more clinical studies, and the one or more medical management plans,
generate, as a function of the patient information, the clinician discretion factor, the one or more clinical studies, and the one or more medical management plans, a set of selections for requesting a clinical order to obtain new patient information, wherein the selections are ordered according to a significance value calculated using the clinician discretion factor, and
transmit, via the network, the set of ordered selections to the mobile device, the transmission activating an application on the mobile device to cause the set of ordered selections to display on the mobile device.

18. The system for interactive clinical decision making of claim 17, the system further comprising:
one or more hardware sensors, configured to sense at least part of the patient information and communicate the sensed data to at least one of the sever and the mobile device.

19. The system for interactive clinical decision making of claim 17, wherein the mobile device includes a hardware sensor configured to sense at least part of the patient information.

20. The system for interactive clinical decision making of claim 17, wherein the server is further configured to
receive a preferred selection from the external device, and
process a respective clinical order to obtain new patient information by adding the clinical order to an electronic schedule or alerting a clinical staff to perform a task.
